(19) United States
(12) Patent Application Publication
(10) Pub. No.: US 2005/0047839 A1
(43) Pub. Date: Mar. 3, 2005

(54) Belt, magnetic roller, method for producing thereof, and image forming apparatus using the same

(76) Inventors: Tadafumi Shimizu, Ogori (JP); Kenji Asakura, Soraku-Gun (JP); Yoshitaka Kitaoka, Osaka (JP); Noboru Katakabe, Uji (JP); Akira Kumon, Katano (JP); Haruhiko Yoshida, Amagasaki (JP); Ryouhei Matsui, Ikoma-Gun (JP); Emiko Nakahata, Tenri (JP); Yoshiko Maeda, Yao (JP); Yoshihiro Nakahata, Kashiba (JP); Masaharu Tonoo, Uda-Gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/751,447

(22) Filed: Jan. 6, 2004

(30) Foreign Application Priority Data
Jan. 7, 2003 (JP) 2003-000822
Jan. 24, 2003 (JP) 2003-016135
Nov. 7, 2003 (JP) 2003-378958

(51) Int. Cl. G03G 15/20

(52) U.S. Cl. 399/333

(57) ABSTRACT

A release layer, which contains fluoropolymers is applied on a die surface of a shaping die, and is baked. An elastic layer is applied onto the external surface of the release layer and is baked. A supporting layer containing heat-resistant synthetic resin is applied onto the external surface of the elastic layer, and is dried. The dried supporting layer is polished to remove the unevenness, and the supporting layer is baked. The release layer, the elastic layer and the supporting layer are turned inside out to be removed from the die surface. The evenness of the fixing belt is improved, and the pressure unevenness is reduced.

### BACKGROUND OF THE INVENTION

1. Field of the Invention

The present invention relates to a method for producing a belt (for example, a fixing belt, a transferring belt, etc.) used for an image forming apparatus, and related arts thereof. In addition, the fixing belt is used as a part of a fixing unit, which heats a toner image and fixes it onto a recording medium in image forming apparatuses, such as an electrophotographic copying machine, facsimile, and printer. A transferring belt is used as a part of a transferring unit, which transfers the toner image formed on an image carrier to the recording medium.

2. Description of the Related Art

The following describes a fixing belt used in image forming apparatuses. Conventionally, a thermal fixing method, in particular, a heat roller fixing method has been generally used as a fixing method.

In the heat roller fixing method, a pair of rollers, which includes a heat roller and a rubber roller, are in press contact. By passing a recording medium, on which the toner image is formed, between the pair of rollers, toner constituting the toner image is heated to melt, thereby the toner is fixed on to the recording medium. In the heat roller fixing method, since the temperature of the whole heat roller is held at a predetermined temperature, it is adequate for high speed image forming, but on the other hand waiting time after the apparatus is powered on is long.

Recently, an endless belt fixing method has been proposed. In this method, the toner on the recording medium is heated through a film-shaped endless belt. In this fixing method, the temperature of the heat roller or the like rises to a predetermined temperature in a short time. In addition, the waiting time after power is turned on can be almost zero and power consumption is less.

As disclosed in published Japanese Patent Application Laid-Open No. 2002-202675, a fixing belt used for this fixing method preferably includes members from the outer layer side as follows:
(1) a release layer, which includes fluoropolymers (for example, 4 fluoridation ethylene polymer (PTFE) etc.), positioned at the outermost layer,
(2) an elastic layer (for example, silicone rubber etc.) positioned between the release layer and a supporting layer,
(3) the supporting layer, which includes heat-resistant synthetic resins (for example, polyimide (PI) etc.), positioned at the innermost layer.

The fixing belt is applicable also to a fixing unit in a full-color image forming apparatus, since the fixing belt can bring toner for a plurality of colors (for example, four colors) in a melted state.

In addition, a desired adhesive layer is conventionally provided between the release layer and the elastic layer, and between the elastic layer and the supporting layer. These adhesive layers do not play an important role in the present invention, therefore, description of the adhesive layers is omitted as far as it is not necessary.

The following describes a conventional method for producing such a kind of fixing belt and a problem therein with reference to FIG. 18 and FIG. 19.

First, as shown in FIG. 18(a), a shaping die 1 with a predetermined shape of a die surface 1a is prepared. In FIG. 18, although the die surface 1a is illustrated as a flat plane for ease of explanation, the die surface 1a is conventionally a surface with a cylindrical shape.

Next, as shown in FIG. 18(b), a release layer 2 containing fluoropolymers is applied on the die surface 1a, and is baked.

Subsequently, as shown in FIG. 18(c), an elastic layer 3 is applied onto the external surface of the release layer 2 (the surface opposite the die surface 1a as viewed from the release layer 2), and is baked.

Consequently, as shown in FIG. 18(d), a supporting layer 4 is applied onto the external surface of the elastic layer 3 (the surface opposite the die surface 1a as viewed from the elastic layer 3), and is baked.

When the supporting layer 4 is applied, the supporting layer 4 is often formed in an uneven thickness, as a thinner part 4a and a thicker part 4b shown in FIG. 18(d).

If the supporting layer 4 with uneven thickness is baked, the following phenomenon occurs.

When the supporting layer 4 is heated to bake, the supporting layer 4 containing polyimide (PI) or the like begins to harden as a result of undergoing imide process. Polyimide contracts in this baking process. The amount of contraction in the thicker part 4b is larger than the thinner part 4a.

In addition, the elastic layer 3 adjacent to the supporting layer 4 can be elastically deformed. Accordingly, the elastic layer 3 becomes unevenly deformed in the parts in contact with the thinner part 4a and the thicker part 4b.

Therefore, after baking, both surfaces of the supporting layer 4 in a fixing belt 5 have an uneven surface as shown in FIG. 18(e).

As shown in FIG. 19, when a recording media (for example, paper etc.) 9 with toner 8 transferred thereon, and the fixing belt 5 are nipped in a nip section between a fixing roller 6 and a press roller 7, uneven pressure is applied to the recording medium 9 depending on the place (whether it is the thicker part or the thinner part, of the supporting layer 4). Therefore, recording quality may deteriorate.

Moreover, published Japanese Patent Application Laid-Open No. 2001-318546 discloses an art that a single heating layer is provided in the fixing belt. However, the art is not sufficient to cope with adverse effect of the uneven thickness described above.

### OBJECTS AND SUMMARY OF THE INVENTION

It is an object of the present invention to provide a method for producing a belt that is capable of preventing deterioration in recording quality caused by uneven thickness, and related technologies thereof.

A first aspect of the present invention provides A method for producing a belt for an image forming apparatus, the method comprising: applying a release layer containing fluoropolymers on a die surface of a shaping die; baking the release layer applied; applying an elastic layer over a surface of the release layer, the surface of the release layer being opposite the die surface as viewed from the release layer; baking the elastic layer applied; applying a supporting layer containing heat-resistant synthetic resin over a surface of the elastic layer, the surface of the elastic layer being opposite the die surface as viewed from the elastic layer; baking the supporting layer applied; removing unevenness of the supporting layer; and releasing the release layer, the elastic layer and the supporting layer from the die surface.

According to the construction described above, the surface of the supporting layer opposite the die surface can be made flat by removing the unevenness of the baked supporting layer. Accordingly, the pressure unevenness applied by the belt is reduced, and it is possible to improve recording quality. Additionally, when the present construction is applied to a fixing belt, the pressure unevenness applied by the fixing belt is reduced, and it is possible to improve recording quality.

In addition, since the unevenness in the supporting layer is removed before undergoing an imide process in the supporting layer, ununiformity in elastic deformation of the elastic layer is also reduced. Therefore, evenness in the belt is furthermore secured.

Here, in a construction according to a prior art, a silicone rubber layer (heat-resistant temperature approximately 250 degrees in Celsius) is formed, as an elastic layer, on an external surface of a polyimide tube as a supporting layer, and fluoropolymers is applied onto the external surface of the elastic layer as a release layer. However, since the heat resistance of the silicone rubber layer is low, it is impossible to bake fluoropolymers at a temperature of approximately 380 or more degrees in Celsius required for baking the fluoropolymers.

On the other hand, in the construction according to the first aspect of the present invention, the processes are reversed in order against the prior art. That is, the elastic layer is formed after a release layer is applied to the shaping die and is baked. Accordingly, in reverse of the prior art, the elastic layer is not hardened by heat, by which the release layer is baked. Moreover, since the die surface is in contact with the release layer, an excellent flat and smooth plane is obtained as compared with the release layer formed by a shaping free surface.

In the description of the first aspect of the present invention, the sentence “applying an elastic layer over a surface of the release layer” means that the elastic layer is applied directly on the surface of the release layer or indirectly with a certain interlayer. The word “over” is used as such meaning in the present invention.

A second aspect of the present invention provides an image forming apparatus comprising: an image carrier operable to retain a toner image; and a transferring belt operable to be transferred thereon the toner image formed on the image carrier, wherein the transferring belt comprises: a release layer containing fluoropolymers and positioning at an outermost layer; a supporting layer containing heat-resistant synthetic resin and positioning at an innermost layer; and an elastic layer positioning between the release layer and the supporting layer, wherein the release layer has a higher coefficient of linear thermal expansion than the supporting layer.

According to the construction described above, it is possible to prevent a problem of perimeter difference caused by the order of layer forming, and a problem of expansion and contraction when the supporting layer and the release layer of the belt are used inside out. Thereby, wrinkles, which appear in the release layer, can be reduced, resulting in that toner can be effectively removed. Furthermore, it is possible to obtain stable color registration by reducing speed variation according to the surface unevenness, resulting in improve recording quality.

A third aspect of the present invention provides a fixing belt comprising: a release layer operable to work in contact with a recording medium; a laminate portion operable to work in contact with a magnetic roller; and an elastic layer positioned between the release layer and the laminate portion, wherein the laminate portion includes a plurality of heating layers and a supporting layer, the plurality of heating layers containing non-magnetic conductive metal and the supporting layer being operable to support the plurality of heating layers.

According to the construction described above, since the plurality of heating layers are made including non-magnetic conductive metal, the heating layers do not hinder an alternating magnetic field produced in the magnetic roller. Thereby, it is possible to improve heating efficiency.

Since a plurality of heating layers is provided, each heating layer generates heat simultaneously. Accordingly, it is possible to improve heating efficiency. Moreover, as compared with a single heating layer, each layer of the plurality of heating layers can be formed thinner by dividing the thickness of the whole heating layer into the respective thickness of the plurality of heating layers. Therefore, resistance of each heating layer becomes relatively large, generating more Joule heat. Thereby, it is possible to improve heating efficiency.

Even if the thickness of each heating layer varies point to point, the total thickness of the plurality of heating layers becomes rather uniform, averaging or canceling out in each layer. Consequently, the fixing belt as a whole can generate heat evenly.

A fourth aspect of the present invention provides a fixing belt according to the third aspect or the present invention, wherein the heating layers are provided at a closer position to the recording medium than to the magnetic roller in the laminate portion.

According to the construction described above, the plurality of heating layers are located closer to the recording medium to be heated, so that resistance against heat conduction between the heating layers and the recording medium can be reduced. Thereby, the recording medium can be efficiently heated.

A fifth aspect of the present invention provides a fixing belt according to the third aspect or the present invention, wherein a layer of the plurality of heating layers is formed thinner than the other heating layer(s), the layer being located at a closest position to the recording medium.

According to the construction described above, resistance of the heating layer located at the closest position to the recording medium is relatively larger than those of the other heating layer(s), so that the heating layer located at the closest position to the recording medium generates more Joule heat. Accordingly, a recording medium can be heated more efficiently.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a sectional view of an image forming apparatus according to Embodiment 1 of the present invention;

FIG. 2 is a sectional view of a fixing unit according to Embodiment 1 of the present invention;

FIG. 3 is a flowchart illustrating each process according to Embodiment 1 of the present invention;

FIGS. 4(a) to 4(f) are sectional views illustrating formation processes of respective layers according to Embodiment 1 of the present invention;

FIG. 5 is a perspective diagram schematically showing a fixing belt producing apparatus according to Embodiment 1 of the present invention;

FIG. 6 is a perspective diagram schematically showing a polishing apparatus according to Embodiment 1 of the present invention;

FIG. 7 is a magnified sectional view of a nip section according to Embodiment 1 of the present invention;

FIG. 8 is a flowchart illustrating each process according to Embodiment 2 of the present invention;

FIGS. 9(a) to 9(f) are sectional views illustrating formation processes of respective layers according to Embodiment 2 of the present invention;

FIG. 10 is a sectional view of an image forming apparatus according to Embodiment 3 of the present invention;

FIGS. 11(a) to 11(e) are sectional views illustrating formation processes of respective layers according to Embodiment 3 of the present invention;

FIG. 12 is a sectional view of a fixing belt according to Embodiment 4 of the present invention;

FIG. 13 is a diagram illustrating a heating process by a fixing belt according to Embodiment 4 of the present invention;

FIG. 14 is a sectional view of a fixing belt according to Embodiment 5 of the present invention;

FIG. 15 is a partial sectional view of a fixing belt according to Embodiment 5 of the present invention;

FIG. 16 is a partial sectional view of a fixing belt according to Embodiment 5 of the present invention;

FIG. 17 is a sectional view of a fixing unit according to Embodiment 6 of the present invention;

FIGS. 18(a) to 18(e) are sectional views illustrating formation processes of respective layers in a prior art; and

FIG. 19 is an enlarged sectional view of a prior art nip section.

### DETAILED DESCRIPTION OF THE PREFERRED EMBODIMENTS

Hereinafter, a description is given of embodiments of the invention with reference to the accompanying drawings.

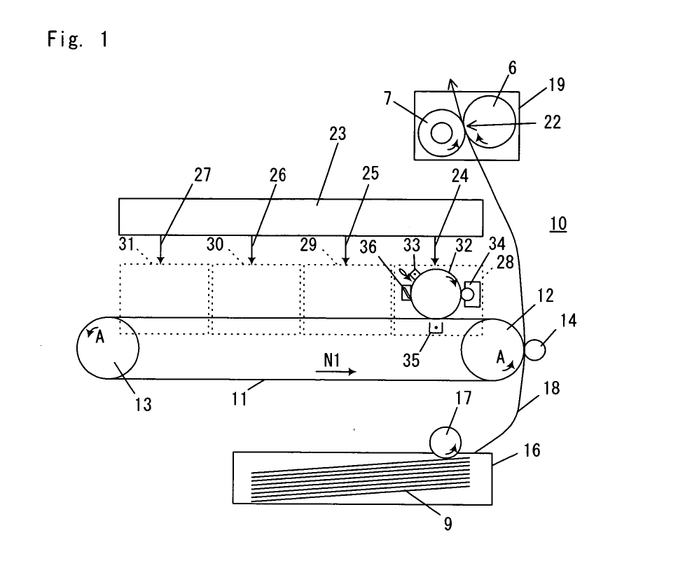

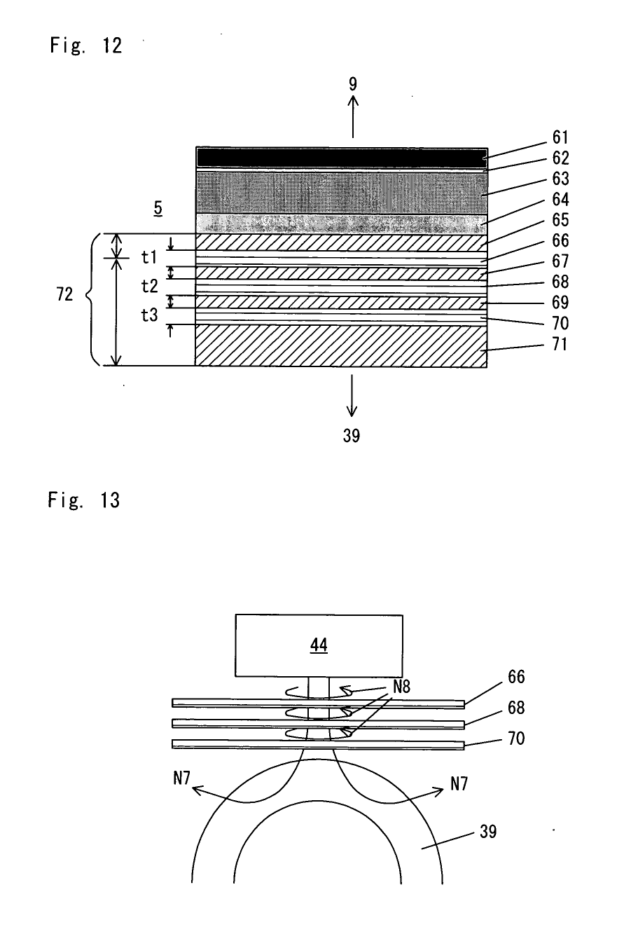

FIG. 1 is a sectional view of an image forming apparatus according to one embodiment of the present invention. In FIG. 1, the same components as those in FIG. 12 and FIG. 13 are attached with the same reference symbols or numerals and their descriptions are omitted.

As shown in FIG. 1, an image forming apparatus 10 adopts an electrophotographic system, specifically, a tandem system. However, the present invention is not limited to an image forming apparatus in the tandem system, and can be applied to various image forming apparatuses with any number of developing portions, with or without a transferring belt.

A transferring belt 11, which is formed endless, is wound around a driving roller 12 and a tension roller 13. The transferring belt 11 retains a developed toner image. The transferring belt travels in a direction of an arrow N1 by rotation of the driving roller 12 and the tension roller 13 in a direction of an arrow A.

In the upper part side of the transferring belt 11, an image forming unit 28 forming a black image, an image forming unit 29 forming a cyan image, an image forming unit 30 forming a magenta image, and an image forming unit 31 forming a yellow image thereon are provided in this order.

These image forming units 28 to 30 assume the same role except for their image colors. Hereinafter, primarily, the image forming unit 28 forming a black image will be described.

A charging portion 33 in this image forming unit 28 uniformly charges the circumferential surface of a photoconductive drum 32 at a predetermined potential.

An exposing portion 23 scans the circumferential surface of the photoconductive drum 32 with a scanning laser beam 24, and forms a latent image corresponding to a black component on the circumferential surface of the photoconductive drum 32. Similarly, also in the image forming units 29 to 30 of the other colors, the photoconductive drums are scanned by scanning laser beams 25 to 27 from the exposing portion 23, and the latent images corresponding to the respective color components are formed.

A developing portion 34 develops the latent image formed on the circumferential surface of the photoconductive drum 32. A transferring unit 35 transfers the toner image, which is developed on the circumferential surface of the photoconductive drum 32, onto the transferring belt 11.

A cleaner 36 removes residual toner, which remains on the circumferential surface of the photoconductive drum 32, after the toner image is transferred onto the transferring belt 11.

In addition, the other toner images are sequentially transferred onto the transferring belt 11 by the image forming units 29 to 31 for respective components of cyan, magenta, and yellow. Then, a full-color toner image is formed on the transferring belt 11 by registration of the four color components.

Additionally, recording medium 9, such as recording paper, are accommodated in a paper feeding cassette 16. The recording medium 9 is fed forward on a conveying path 18 sheet by sheet by a pickup roller 17.

A transferring roller 14 faces the driving roller 12. The transferring belt 11 and the recording medium 9 conveyed through the conveying path 18 are nipped between the driving roller 12 and the transferring roller 14. The full-color toner image is transferred onto the recording medium 9 in one step by pressing the recording medium 9 against the transferring belt 11.

After the one-step transferring process, the recording medium 9 is conveyed through the conveying path 18, and passes a nip section 22 in a fixing unit 19. The recording medium 9, with the full-color toner image (not fixed yet) transferred thereon in one-step, is nipped between a fixing roller 6 and a press roller 7 at high temperatures. When passing through the nip section 22, the toner constituting the full-color toner image is melted and pressed. Consequently, the full-color toner image is fixed onto the recording medium 9.

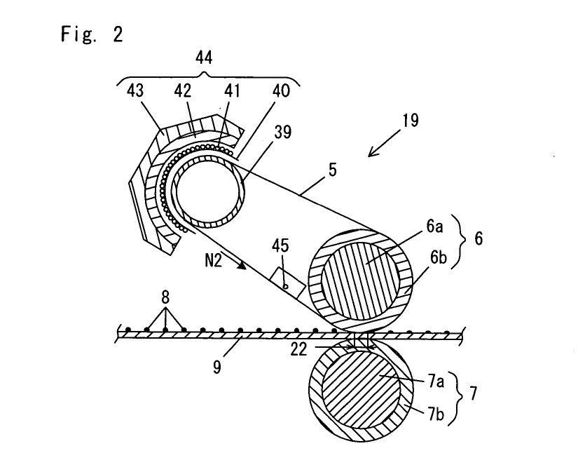

Next, the fixing unit 19 is described with reference to FIG. 2. FIG. 2 is a sectional view of a fixing unit according to one embodiment of the present invention.

First, as shown in FIG. 2, the press roller 7 includes a cylindrical shape of core metal 7a, which is formed of metal with high heat conduction (for example, stainless steel, aluminum, etc.), and an elastic portion 7b, which covers the circumferential surface of the core metal 7a. The elastic portion 7b is formed of material with excellent heat resistance and with an excellent toner-releasing characteristic.

The press roller 7 presses the fixing roller 6 via a fixing belt 5 in the nip section 22.

Additionally, in the present embodiment, the outer diameter of the press roller 7 is approximately 30 mm same as the fixing roller 6. The thickness of the elastic portion 7b of the press roller 7 is approximately 2-5 mm so as to be thinner than the thickness of an elastic portion 6b of the fixing roller 6. The hardness of the press roller 7 is approximately 20-80 degrees (Asker C) so as to be harder than the fixing roller 6.

Thereby, the action of toner-releasing can be improved at an exit of the nip section 22.

A heat roller 39 is formed in a cylindrical hollow shape (for example, outer diameter: 20 mm, and wall thickness: 0.3 mm) of a magnetic metal member. The thermal capacity of the heat roller 39 is low, thereby the temperature of the heat roller 39 quickly rises.

The fixing roller 6 includes a cylindrical shape of core metal 6a, which is formed of metal (for example, stainless steel, etc.), and an elastic portion 6b, which covers the circumferential surface of this core metal 6a. This elastic portion 6b is formed of silicone solid rubber or silicone foam rubber with heat resistance.

Additionally, in this embodiment, the outer diameter of the fixing roller 6 is approximately 30 mm same as the heat roller 39. The thickness of elastic portion 6b is approximately 3-8 mm. The hardness of the elastic portion 6b is approximately 15-50 degrees (Asker C). For this reason, in the nip section 22, a contact part with a predetermined width is formed between the fixing roller 6 and the press roller 7 by the thrusting pressure from the press roller 7.

The press roller 39 is heated by an inductive heating portion 44 as described below. The fixing belt 5 is wound around the fixing roller 6 and the heat roller 39, and in contact with the circumference of the press roller 39.

Therefore, as the fixing roller 6 is rotated by a drive unit (not shown), the fixing belt 6 is rotated in the direction of an arrow N2. The inside of the fixing belt 5 is continuously and entirely heated.

The inductive heating portion 44 includes the following components. A guide plate 40 is formed in a half circular shape so as to surround the circumference of the heat roller 39. The guide plate 40 is positioned adjacent to the heat roller 39.

An exciting coil 41 is formed of one long exciting coil wire material surrounding alongside the guide plate 40 toward the axis of the heat roller 39. The surrounding length is the same length as the contact part between the fixing belt 5 and the heat roller 39.

Thus, the inductive heating portion 44 can effectively heat the heat roller 39 with electromagnetic induction, and can obtain a maximum time in contact between the heat roller 39 generating heat, and the fixing belt 5. Accordingly, thermal conduction efficiency can be high.

The exciting coil 41 is connected to a driving power supply (not shown) with a frequency-variable oscillating circuit, and is excited.

A half circular shape of core 42, which is formed of ferromagnetic substances, such as a ferrite, is positioned in further outside of the exciting coil 41. This core 42 is fixed to a support member 43, and is supported at the position adjacent to the exciting coil 41. In this embodiment, the relative permeability of the core 42 is 2500.

The driving power supply (not shown) supplies 10 kHz to 1 MHz of a high frequency alternating current, preferably 20 kHz to 800 kHz of a high frequency alternating current, to the exciting coil 41. Thereby, an alternating magnetic field is produced around the exciting coil 41.

This alternating magnetic field acts on the heating layer of the heat roller 39 in an area and the vicinity of the area where the heat roller 39 and the fixing belt 5 are in contact. Then, an eddy current flows inside the heating layer, in the direction that the eddy current hinders the variation of the alternating magnetic field.

Joule heat is generated by this eddy current and the electric resistance of the heat roller 39 and so on. Thus, heat roller 39 and so on generates heat by electromagnetic induction.

As shown in FIG. 2, a temperature sensor 45 such as a thermistor is in contact with the inner side of the fixing belt 5 in the area near the feed-in side of the nip section 22, and detects the temperature of the inner side of the fixing belt 5.

(Embodiment 1)

A method for producing a fixing belt according to Embodiment 1 of the present invention comprises:
applying a release layer containing fluoropolymers on a die surface of a shaping die;
baking the release layer applied;
applying an elastic layer over a surface of the release layer, the surface of the release layer being opposite the die surface as viewed from the release layer;
baking the elastic layer applied;
applying a supporting layer containing heat-resistant synthetic resin over a surface of the elastic layer, the surface of the elastic layer being opposite the die surface as viewed from the elastic layer;
baking the supporting layer applied;
removing unevenness of the supporting layer; and
releasing the release layer, the elastic layer and the supporting layer from the die surface.

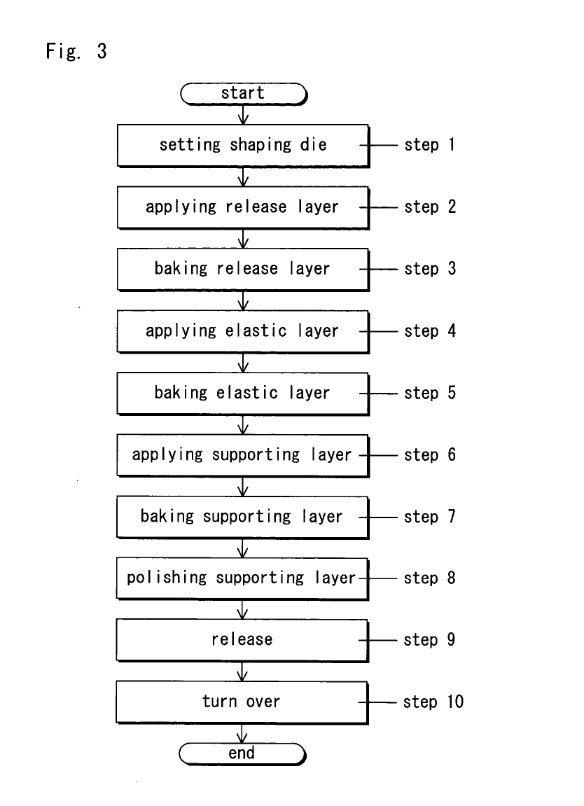

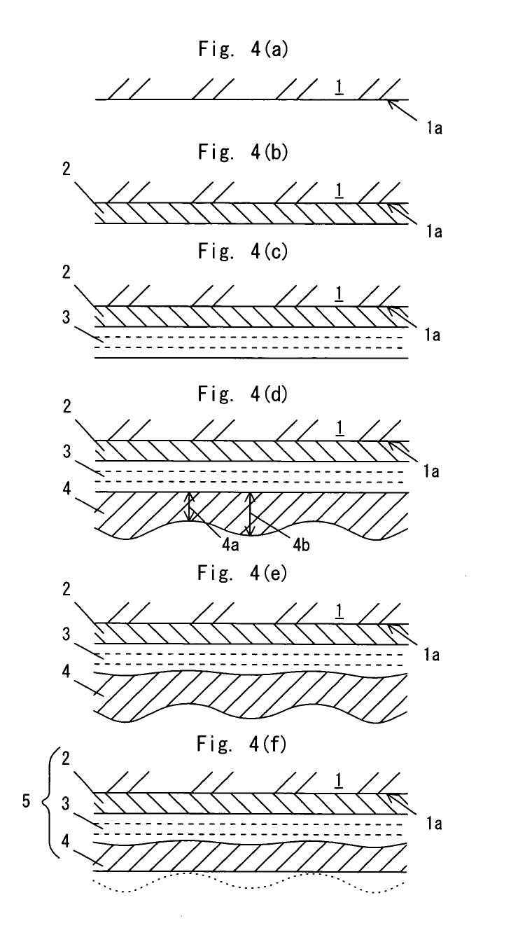

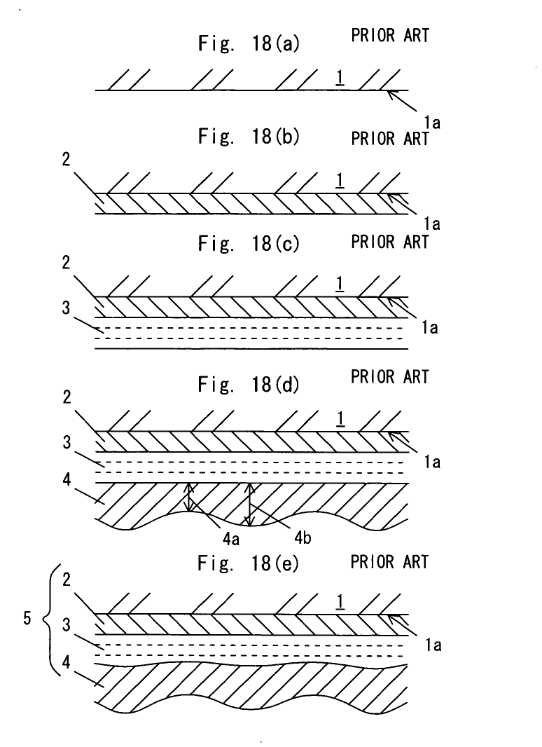

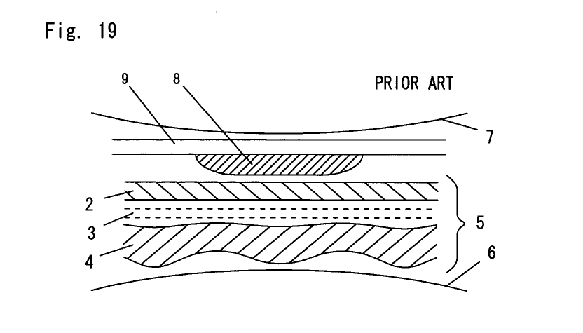

FIG. 3 is a flowchart showing each process according to Embodiment 1 of the present invention. FIGS. 4(a) to 4(f) are sectional views illustrating the forming process of the respective layers. In FIG. 4, the die surface 1a is illustrated, for convenience, as a flat plane as in FIG. 18, however, the die surface 1a is actually a surface of a cylindrical shape.

Each layer of the fixing belt 6 is described. First, the release layer 2 is described. It is preferable that the fluoropolymers used for a release layer 2 is at least one selected from the group including tetrafluoroethylene polymer (PTFE), tetrafluoroethylene-perfluoroalkoxyethylene copolymer (PFA), and fluoridation ethylene propylene copolymer (PFEP).

In addition, it is preferable that the baking temperature of the release layer 2 is 330-430 degrees in Celsius. In this temperature range, the release layer 2 can be preferably formed, and degradation of the release layer 2 can be prevented. Additionally, it is preferable that the thickness of the release layer 2 after baking is 5-50 μm. In this thickness range, the abrasion durability of the release layer 2 is excellent, and the surface hardness is high, and fracture of the release layer 2 can be prevented. In particular, it is more preferable that the range is 15-25 μm.

The fixing belt including these fluoropolymers as the release layer 2 is excellent in fixability, surface hardness, surface die-releasing, surface roughness, durability, and film thickness flexibility. Especially, the fixing belt is excellent in toner-fixing, toner-releasing, and durability of the release layer 2.

Conductive material, abrasion proof material, and material with high heat conductivity may be added as filler in the fluoropolymers if necessary.

Next, the elastic layer 3 is described. It is preferable that the elastic layer 3 is silicone rubber with JIS hardness A1-A80 degrees. In this JIS hardness range, the strength and the adhesiveness of the elastic layer 3 can be sufficient, preventing poor fixing. Concretely, silicone rubber of one-component system, two-component system, three-component system, or a greater number-component system, silicone rubber of an RTV type or an HTV type, silicone rubber of a condensation type, or addition type, or the like, can be used as this silicone rubber.

In addition, it is preferable that the baking temperature of the elastic layer 3 is 150-300 degrees in Celsius. In this temperature range, while a residue of a volatile component in the elastic layer 3, and a deficiency in strength can be prevented, degradation and hardening do not occur in the elastic layer 3. It is preferable that the thickness of the elastic layer 3 after baking is 30-1000 μm. In this thickness range, while the elastic layer 3 has an elastic effect, a thermal insulation property can be kept low. Accordingly, an energy-saving effect can be high. In particular, it is more preferable that the range is 150-300 μm.

Next, the supporting layer 4 will be described. It is preferable that the supporting layer 4 is formed of heat-resistant synthetic resin. It is preferable that the heat-resistant synthetic resin is polyimide (PI) or polyamide imide (PAI).

It is preferable that the baking temperature of the supporting layer 4 is 150-300 degrees in Celsius. In this temperature range, reduction in strength of the supporting layer 4, and deterioration in the elastic layer 3 can be prevented. It is preferable that the thickness of the supporting layer 4 after baking is 50-200 μm. In this thickness range, while the supporting layer 4 has strength, the abrasion durability and reduction in elasticity of the supporting layer is prevented and its thermal insulation property can be kept low. Accordingly, an energy-saving effect can be high. The supporting layer 4 will be polished to remove the surface unevenness as described below. Therefore, the supporting layer 4 has additional thickness (for example, approximately 5-20 μm) for polishing.

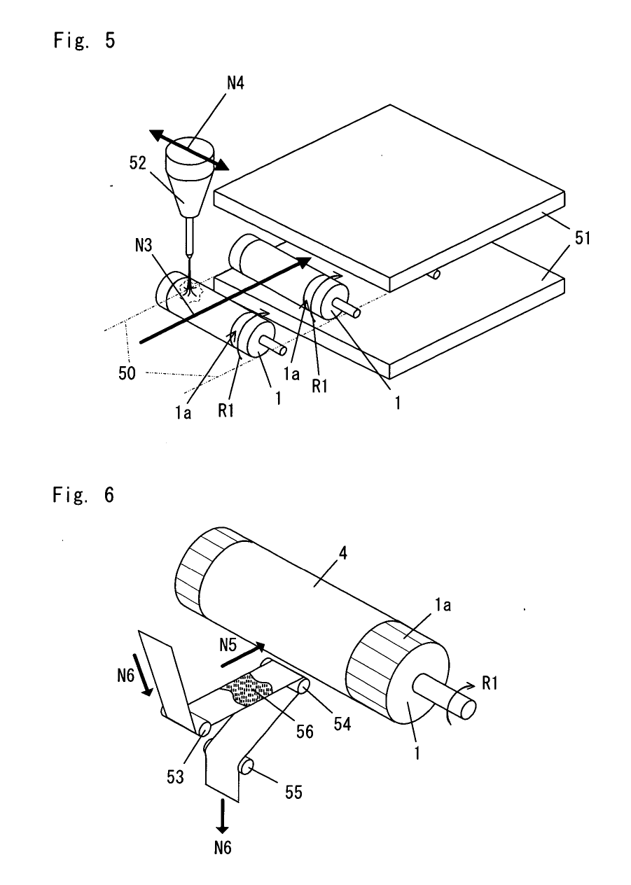

Next, a method for producing a fixing belt according to Embodiment 1 will be described. First, the processes for applying, drying, and baking each layer are described with reference to FIG. 5, before each process is described with reference to FIG. 3 and FIG. 4. Then, the process for polishing a supporting layer will be described with reference to FIG. 6.

FIG. 5 is a perspective diagram schematically showing a fixing belt producing apparatus according to one embodiment of the present invention.

As shown in FIG. 5, the producing apparatus has an applying stage at the near side, and a heater stage at the far side. The shaping die 1 travel through the applying stage and the heater stage along a travel path 50 in the direction of an arrow N3, while rotating in the direction of an arrow R1 by a rotating means (not shown).

An applicator 52 is provided in the applying stage. The applicator 52 has a spray to apply resin, etc. vertically and downward to the die surface 1a of the shaping die 1. The applied resin, etc. makes each layer on the die surface. The applicator 52 moves back and forth in the direction of an arrow N4 by a conveying means (not shown). Thereby, the applicator 52 applies resin evenly onto the die surface 1a.

A heater 51 is provided in the heater stage. Heating conditions (time, temperature, etc.) of the heater 51 are set according to a predetermined profile. Accordingly, it is possible to dry or to bake each layer applied onto the outermost circumference of die surface 1a.

FIG. 6 is a perspective diagram schematically showing a polishing apparatus according to one embodiment of the present invention. As shown in FIG. 6, in this polish apparatus, the shaping die 1 is supported in a rotatable manner similar to FIG. 5. The shaping die 1 rotates in the direction of an arrow R1.

Additionally, a first roller 53, a second roller 54, and a third roller 54 are deployed in a V-shape as viewed in a vertical section, so that their axes are parallel to the rotating axis of the shaping die 1. A file belt 56 is stretched by the first roller 53, the second roller 54, and the third roller 54, in this order as shown in FIG. 6. The file belt 56 is approximately #400 and has at least one friction surface facing the die surface 1a.

The second roller 54 is brought in contact with the supporting layer 4 positioned at the outermost circumference of the die surface 1a, as shown by an arrow N5. While the shaping die 1 rotates in the direction of the arrow R1, a part of the file belt 56, the part surrounding the second roller 54, travels in the axis direction of the shaping die 1, thereby polishing the perimeter part of the supporting layer 4. According to research by the inventors of the present invention, the maximum unevenness of the supporting layer 4 was approximately 5-8 μm before polishing. Therefore, polishing the supporting layer 4 by a thickness of approximately 10 μm was found sufficient in order to eliminate the unevenness.

The above values are only illustrative and the present invention is not specifically limited to these values.

Moreover, in order to refresh the friction surface of the file belt 56, what is required is to only convey the file belt 56 by a predetermined amount in the direction of an arrow N6.

Based on the explanation described above, each process of the method for producing the fixing belt 5 according to Embodiment 1 is described, with reference to FIG. 3 and FIG. 4.

First, in step 1 of FIG. 3, a shaping die 1 with a predetermined shape of die surface 1a is prepared as shown in FIG. 4(a). In FIG. 4, although the die surface 1a is illustrated as a flat plane, the die surface 1a of the embodiment is actually a surface of a cylindrical shape, which is a convex shape facing downward.

Next, in step 2 of FIG. 3, a release layer 2 containing fluoropolymers is applied onto the die surface 1a, as shown in FIG. 4(b). This application is performed at the applying stage of FIG. 5.

In step 3 of FIG. 3, the shaping die 1 is conveyed to the heater stage from the applying stage, and is heated by the heater 51, and the applied release layer 2 is baked.

Next, in step 4 of FIG. 3, a shaping die 1 is returned to the applying stage from the heater stage, an elastic layer 3 is applied onto the external surface of the release layer 2 (the surface opposite the die surface 1a as viewed from the release layer 2), as shown in FIG. 4(c).

Subsequently, in step 5 of FIG. 3, the shaping die 1 is conveyed to the heater stage from the applying stage, and is heated by the heater 51, and the applied elastic layer 3 is baked.

In step 6 of FIG. 3, the shaping die 1 is returned to the applying stage from the heater stage, a supporting layer 4 is applied onto the external surface of the elastic layer 3 (the surface opposite the die surface 1a as viewed from the elastic layer 3), as shown in FIG. 4(d).

In step 7 of FIG. 3, the shaping die 1 is conveyed to the heater stage from the applying stage, and is heated by the heater 51, and the applied supporting layer 4 is baked.

As described in the background art, when the supporting layer 4 is applied, the supporting layer 4 is often formed in an uneven thickness, with a thinner part 4a and a thicker part 4b as shown in FIG. 4(d). When the supporting layer 4 with uneven thickness is baked as it is, the fixing belt has unevenness.

Therefore, in step 8 of FIG. 3, the outermost circumference of supporting layer 4 is polished, as shown in FIG. 4(f), to remove an appropriate amount by using the polishing apparatus of FIG. 6. Thereby, the unevenness is removed, and the fixing belt 5 has a smooth external surface.

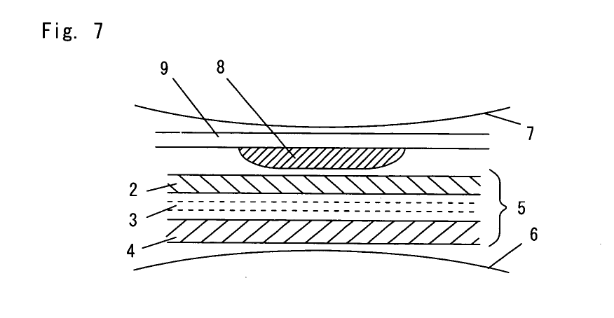

As shown in FIG. 7, when the recording medium 9 (for example, paper, etc.), on which toner 8 is transferred, and the fixing belt 5 is nipped between the fixing roller 6 and the press roller 7 in the nip section, uniform pressure acts on the recording medium 9 by the fixing belt 5 with excellent evenness. Therefore, it becomes possible to obtain high recording quality.

Then, in step 9 of FIG. 3, the fixing belt 5 is released from the die surface 1a. In step 10 of FIG. 3, the fixing belt 5 is turned inside out.

In this embodiment, the unevenness of the supporting layer 4 is removed by polishing the supporting layer 4.

In this construction, the unevenness of the supporting layer 4 can be removed easily without hindering the applying process and the baking process of respective layers 2 and 3

In this embodiment, during or after releasing the release layer 2, the elastic layer 3 and the supporting layer 4 from the die surface 1a, the method includes a step of turning the release layer 2, the elastic layer 3 and the supporting layer 4 inside out as one body.

Turning it inside out can provide an effect that the wrinkles of unevenness on the release layer 2 are reduced. That is, while the release layer 2 is formed at the closer side to the die surface 1a than the supporting layer 4 initially, the release layer 2 is pulled in the circumferential direction after the belt is turned inside out. Accordingly, the wrinkles of unevenness on the release layer 2 can be made smaller.

In this embodiment, the fluoropolymers is at least one selected from the group including tetrafluoroethylene polymer (PTFE), tetrafluoroethylene-perfluoroalkoxyethylene copolymer (PFA), and fluoridation ethylene propylene copolymer (PFEP).

In this construction, the toner-releasing characteristic is kept preferably.

In this embodiment, the heat-resistant synthetic resin is at least one selected from the group including polyimide (PI) and polyamide imide (PAI).

In this construction, it is possible to provide the supporting layer 4 that has excellent strength, heat resistance and cost advantage.

(Embodiment 2)

A method for producing a fixing belt according to Embodiment 2 of the present invention comprises:
applying a release layer containing fluoropolymers on a die surface of a shaping die;
baking the release layer applied;
applying an elastic layer over a surface of the release layer, the surface of the release layer being opposite the die surface as viewed from the release layer;
baking the elastic layer applied;
applying a supporting layer containing heat-resistant synthetic resin over a surface of the elastic layer, the surface of the elastic layer being opposite the die surface as viewed from the elastic layer;
drying the supporting layer applied;
removing unevenness of the dried supporting layer;
baking the supporting layer; and
releasing the release layer, the elastic layer and the supporting layer from the die surface.

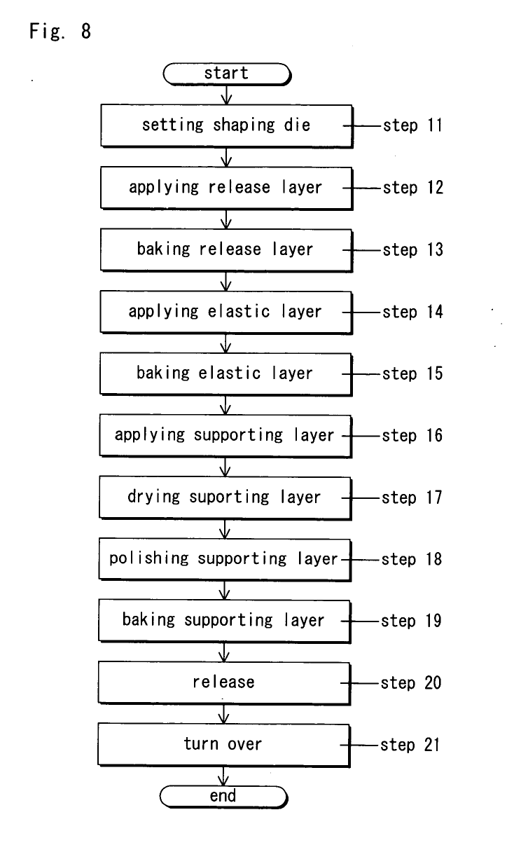

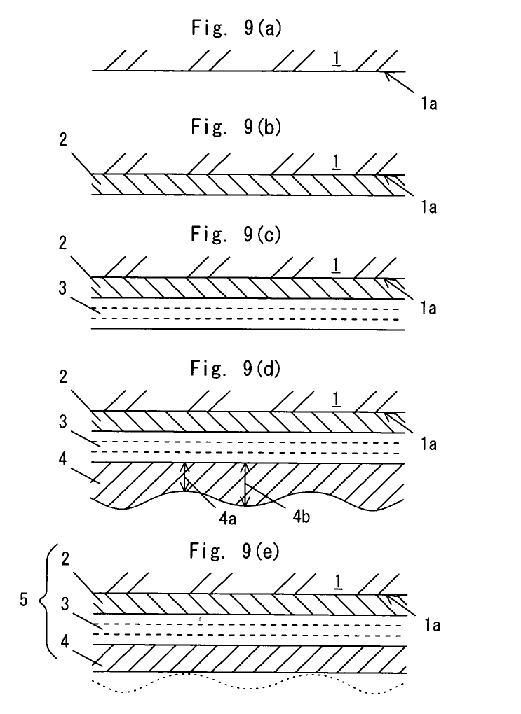

Hereinafter, in this embodiment, the difference between this embodiment and Embodiment 1 will be mainly described. Next, a method for producing the fixing belt 5 according to Embodiment 2 will be described with reference to FIG. 8 and FIG. 9.

First, in step 11 of FIG. 8, a shaping die 1 with a predetermined shape of die surface 1a is prepared, as shown in FIG. 9(a).

Next, in step 12 of FIG. 8, a release layer 2 containing fluoropolymers is applied onto the die surface 1a, as shown in FIG. 9(b). This application is performed at the applying stage of FIG. 5.

Then, in step 13 of FIG. 8, the shaping die 1 is conveyed to the heater stage from the applying stage, and is heated by the heater 51, and the applied release layer 2 is baked.

Next, in step 14 of FIG. 8, the shaping die 1 is returned to the applying stage from the heater stage as shown in FIG. 9(c), an elastic layer 3 is applied onto the external surface of the release layer 2 (the surface opposite the die surface 1a as viewed from the release layer 2).

Then, in step 15 of FIG. 8, the shaping die 1 is conveyed to the heater stage from the applying stage, and is heated by the heater 51, and the applied elastic layer 3 is baked.

Furthermore, in step 16 of FIG. 8, the shaping die 1 is returned to the applying stage from the heater stage as shown in FIG. 9(d), a supporting layer 4 is applied onto the external surface of the elastic layer 3 (the surface opposite the die surface 1a as viewed from the elastic layer 3).

The above processes are similar to those of Embodiment 1. However, in this embodiment, subsequent processes are different.

In step 17 of FIG. 8, the shaping die 1 is conveyed to the heater stage from the applying stage, and is heated by the heater 51, and the applied supporting layer 4 is dried. The drying process can be 10 to 15 minutes at 200 degrees in Celsius as a heating condition by the heater 51, for example.

Next, in step 18 of FIG. 8, the outermost circumference of supporting layer 4 is polished, as shown in FIG. 9(f), to remove an appropriate amount by using the polishing apparatus of FIG. 6. Accordingly, the above unevenness is removed, and the fixing belt 5 has a smooth external surface.

Then, in step 19 of FIG. 8, the shaping die 1 is conveyed to the heater stage from the applying stage, and is heated by the heater 51, and the polished supporting layer 4 is baked.

Then, in step 20 of FIG. 8, the fixing belt 5 is released from the die surface 1a. The fixing belt 5 is turned inside out. The other processes are similar to Embodiment 1.

In this embodiment, the unevenness of the dried supporting layer is removed. Accordingly, the surface opposite the die surface of the supporting layer can be flat, and the unevenness of the dried supporting layer is removed before undergoing the imide process in the supporting layer. Therefore, the unevenness of the elastic deformation of an elastic layer is also reduced by reducing variation in the amount of contraction when baking. The evenness of the fixing belt is further secured.

(Embodiment 3)

In Embodiments 1 and 2, the present invention is applied to a fixing belt. However, the present invention is applicable also to a transferring belt as described below.

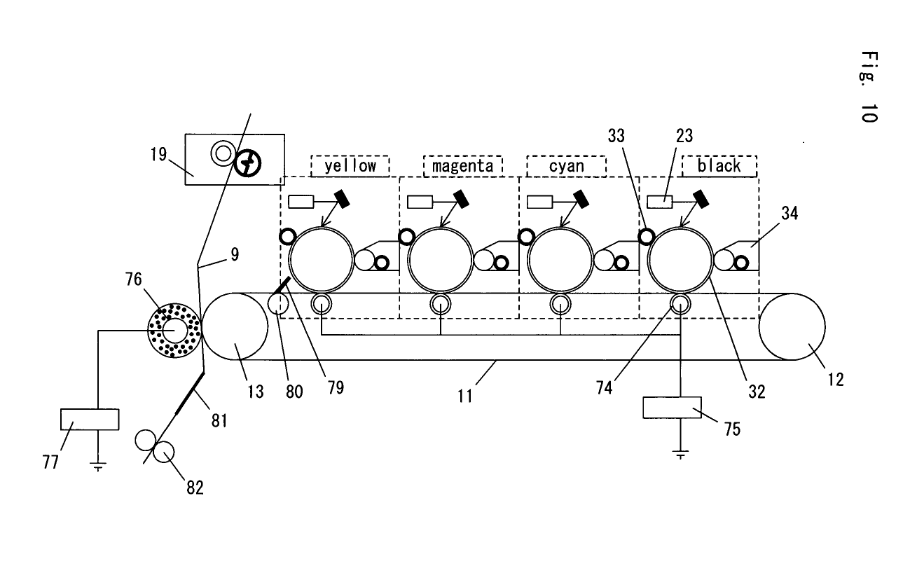

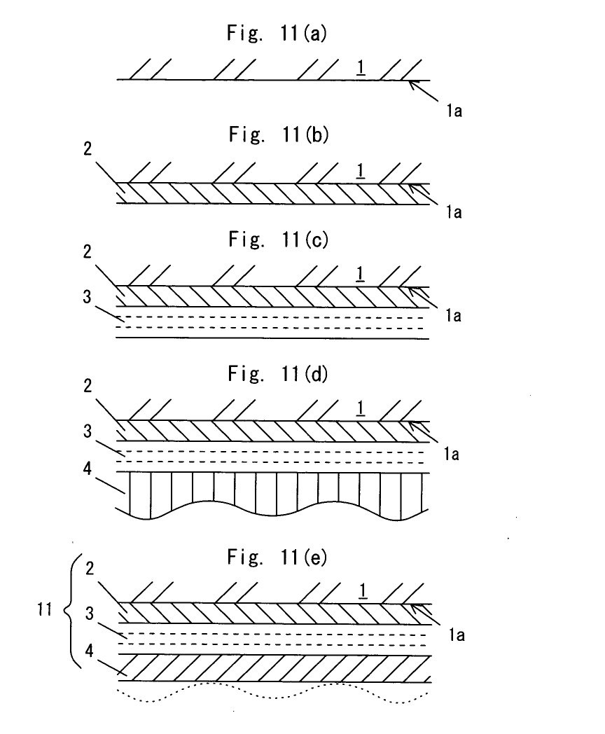

Hereinafter, an image forming apparatus according to Embodiment 3 is described, with reference to FIG. 10 and FIG. 11. FIG. 10 is a sectional view of an image forming apparatus according to Embodiment 3 of the present invention.

The image forming apparatus in FIG. 10 is a tandem system of an image apparatus similar to FIG. 1. However, the present invention is not limited to a tandem system of an image forming apparatus and can be applied to various image forming apparatuses, such as a monochrome image forming apparatus or an image forming apparatus using a surface sequential system.

In this embodiment, the image forming apparatus can form an image for an A4 size of medium (width, 197 mm). An axis with a length 210-230 mm (the longitudinal direction is perpendicular to the paper in FIG. 10) is used except otherwise noted. Additionally, the same components as in FIG. 10 are attached with the same reference symbols or numerals of those of FIG. 1.

In FIG. 10, a photoconductive drum 32 corresponds to a role as an image carrier. The photoconductive drum 32, a charging portion 33, and a developing roller can be rollers with arbitrary diameters, respectively. In this Embodiment 3, their diameters are 24 mm, 12 mm, and 20 mm, respectively.

The photoconductive drum 32 is an organic photoconductive drum (OPC) with a photosensitive layer with a thickness approximately 15-20 μm formed on an aluminum raw drum with a 0.8-mm thickness. An exposing portion 23 forms a latent image on the photoconductive drum 32 by scanning with a laser beam. In FIG. 10, although a laser optical system is described, an LED array head or the like can be used.

The charging portion 33 is in contact with the photoconductive drum 32 at approximately 500-1000 g of pressure (a 210-mm width in the axis direction), and rotates in the same direction as the photoconductive drum 32. The charging portion 33 includes a conductive elastic layer formed on the circumference of a metal axis. The surface of the photoconductive drum 32 is charged at a desired potential by applying voltage from a metal axis.

In this embodiment, the charging portion 33 includes the elastic layer (resistance: 106 Ω·cm, thickness: 3 mm) formed on the metal axis with a diameter of 6 mm. A direct voltage, an alternating voltage, or a superimposed voltage of a direct voltage and an alternating voltage can be used as the applied voltage. Additionally, in this embodiment, the applied voltage is direct voltage of 1000 V, and the surface potential of the photoconductive drum 32 is approximately 500 V.

Similar to FIG. 1, in order to form a full-color image, the same photoconductive drums 32 and the same members provided adjacent to them corresponding to yellow, magenta, cyan, and black toner can be used.

Next, a transfer portion is described. In FIG. 10, a transferring belt 11 is an endless type without a joint. The details of the method for producing a transferring belt 11 are described later. The transferring belt 11 is stretched by a driving roller 12 and a tension roller 13.

The driving roller 12 rotates the transferring belt 11. Metal such as aluminum and iron, metal plated by nickel, or the like, can be used as the driving roller 12. Furthermore, metal covered by rubber such as urethane and silicone with a high friction coefficient can also be used in order to prevent slipping on the transferring belt 11.

The outer diameter of a driving roller 12 is f16 mm in this embodiment. This outer diameter is nearly one third of the interval (in this embodiment, 45 mm) among the photoconductive drums 32 corresponding to respective colors (yellow, magenta, cyan, and black).

A spring (not shown) or the like thrusts the tension roller 13 and provides a tension (for example, approximately 100 N) to the transferring belt 11. While the transferring belt 11 does not act in relation to image forming, the tension roller 13 may not provides tension. Moreover, in this embodiment, the tension roller 13 is grounded electrically.

First transferring rollers 74 are provided so as to face the photoconductive drums 32 corresponding to the respective colors (yellow, magenta, cyan, and black) via the transferring belt 11. In this embodiment, the positional relationship between the photoconductive drums 32 and the first transferring rollers 74 is predetermined so that the center of each photoconductive drum 32 and the center of each first transferring roller 74 are located at the same position in the traveling direction of the transferring belt 11. However, their locations are not specifically limited. For example, the center of first transferring roller 74 may be displaced by several mm downstream in the traveling direction.

The first transferring roller 74 of this embodiment includes a sponge layer (polyurethane foam rubber with 3-mm thickness and 25 hardness (Asker C)) on the surface of a metal axis (6 mm in diameter) in this embodiment. Then, the pressure 300 g (a 210-mm width in the directions of an axis) toward the photoconductive drum 32 is applied to both ends of the first transferring roller 74 with an outer diameter 12 mm. Thereby, the first transferring roller 74 presses the photoconductive drum 32 through the transferring belt 11.

In this embodiment, when the voltage of 1000V is applied, resistance is 5×103 Ω. As a matter of course, the resistance is not specifically limited, and can be 1×108 Ω or less, for example. In addition, when the center of the first transferring roller 74 is displaced downstream in the traveling direction of the transferring belt 11 with respect to the center of the photoconductive drum 32, the first transferring roller 74 may be made only by a metal axis (without a sponge layer).

Each first transferring roller 74 is connected to a first transfer power supply 75. In this embodiment, the first transferring rollers 74 corresponding to four colors are connected to the first transfer power supply 75 as a common power supply. Each of them may be connected to an individual power supply corresponding to each color. Moreover, a resistor with different resistance corresponding to the respective colors may be inserted between the first transfer power supplie 75 and the first transferring roller 74.

In this embodiment, a constant voltage system outputting constant voltage is used for the first transfer power supply 75. It is not specifically limited, and a constant current system outputting constant current or a mixed power supply (constant current-constant voltage) with a feedback control may also be used.

A second transferring roller 76 transfers the toner image (monochrome or a plurality of colors) on the transferring belt 11 to a recording medium (a second image carrier) 9. The second transferring roller 76 is connected to a second transfer power supply 77. A power supply similar to the first transfer power supply 75 can be used for the second transfer power supply 77.

In addition, the voltage/current applied to the second transferring roller 76 can be determined based on the current flowing through the tension roller 13, while the recording medium 9 does not pass.

A roller similar to the first transferring roller 74 can be used for the second transferring roller 76. In this embodiment, the second transferring roller 76 includes a sponge layer (including a foam sponge, such as urethane with a thickness of 5 mm, hardness (Asker C) 45 degrees) formed on a metal axis (f12 mm), and has an outer diameter of 22 mm. Its hardness is not specifically limited. The hardness may be 60 degrees or less according to the JIS hardness A scale.

Moreover, in this embodiment, both ends of a transferring belt 11 are pressed with the force of 15 N per one side. The second transferring roller 76 can include the above sponge layer. Moreover, a covering layer may be provided on the surface of the sponge layer. When a voltage of 1000 V is applied, the resistance is 5×106 Ω, but the resistance is not specifically limited. The resistance may be 1×106 to 1×108 Ω.

A paper-inserting guide 81 is composed of a metal member, and leads the recording medium 9 toward the position between the second transferring roller 76 and the transferring belt 11, and is grounded directly, or is grounded via a resistance element.

The timing roller 82 temporally retains the recording medium 9 conveyed from a paper tray (not shown), and resumes forwarding the recording medium 9 to adjust the tip portion of an image to the tip of the recording medium 9. The timing roller 82 is directly grounded or is grounded via a resistance element.

A cleaning blade 79 is a cleaning unit for removing toner that remains on the transferring belt 11. A cleaning supporting roller 80 is a supporting unit for supporting the tip edge portion of the cleaning blade 79 through a transferring belt 11.

A single layer rubber such as urethane with JIS hardness A 50 to 90 degrees, or a laminated rubber formed of a plurality of rubber layers with different hardness are used for the cleaning blade 79. In this embodiment, the free-end length of the cleaning blade 79 is 8 mm, and the thickness is 1.6 mm. A cleaning blade 79 is positioned at an angle 10±5° to the longitudinal surface of the transferring belt 11. In the cleaning blade 79, the ratio of the free-end length to the thickness is preferably 4 to 6. Furthermore, it is preferable that Young's modulus of the cleaning blade 79 is 40 to 100 kgf/cm2.

In this embodiment, a metal shaft with f 10 is used as the cleaning support roller 80. The cleaning blade 79 thrusts the transferring belt 11 at 20 gf/cm. The effective range of the thrust is 10 to 30 gf/cm. The intrusion depth is 1 mm. Its preferable range is 0.3 mm to 2.5 mm.

In addition, it is preferable that the surface roughness of the supporting layer in the transferring belt 11 is 10-20 μm in ten-point average surface roughness. It is preferable that the surface roughness of the supporting layer is less than that of the cleaning support roller 80. It is more preferable that the surface roughness of the supporting layer is approximately 5-15 μm.

When the surface roughness is in the range mentioned above, the rigidity of the cleaning support roller 80 is larger than the rigidity of the transferring belt 11. Since the transferring belt 11 conforms with the unevenness of the surface of the cleaning support roller 80, wrinkles do not appear in the surface of the release layer. Therefore, the cleaning characteristic is made preferable. Especially, the cleaning characteristic for the external additive agent added in toner is improved. Therefore, it is preferable.

On the other hand, when the surface roughness of the supporting layer of the transferring belt 11 is larger than the surface roughness of the cleaning support roller 80, the unevenness of the supporting layer of the transferring belt 11 is not cancelled. Wrinkles appear in the surface of the release layer. Therefore, the cleaning characteristic deteriorates.

In addition, the surface roughness of the first transferring roller 74, which supports the transferring belt 11, is made smaller than the surface roughness of the driving roller 12 or the tension roller 13. Thereby, the transferring belt 11 is in closer contact with the driving roller 12 and the tension roller 13. Therefore, the transferring belt 11 travels stably.

Furthermore, since the transferring belt 11 is in closer contact with the rollers 12 and 13, neither toner nor its additive agent enters between them. The transferring belt 11 can travel stably for a long time.

Since the belt is produced with a first step of forming the release layer in this embodiment, the supporting layer can be polished for finishing.

In a conventional method, the belt is produced with a first step of forming the supporting layer. In order to control the surface roughness, high accuracy is required for the surface roughness of a die. Maintenance against flaws or the like is necessary. This increases the cost.

On the other hand, in this embodiment, when the surface roughness is controlled by polishing the supporting layer in the polish process for finishing, such maintenance and costs as described above are not necessary. If the release layer or the elastic layer is improperly formed, the polish process may be stopped from advancing. Therefore it is possible to improve the yield.

Next, the operation of the image forming apparatus in FIG. 10 will be described.

In the case of a tandem system, the image forming process is performed similarly for each color. In the case of yellow as an example, first, the surface of the photoconductive drum 32 is charged uniformly by the charging portion 33. Then, the exposing portion 23 scans the surface of the photoconductive drum 32, and forms an electrostatic latent image based on an image signal. Next, charged toner is supplied to the photoconductive drum 32 from the developing portion 34, and the electrostatic latent image is developed, as a toner image.

A voltage (+400 to 1200 V) opposite in polarity (positive in this embodiment) to the charged polarity (negative in this embodiment) of toner is applied by the first transfer power supply 75 through the first transferring roller 74, which presses from the back of the transferring belt 11. Accordingly, the toner image is transferred onto the transferring belt 11.

In a tandem system, such an image forming process is performed for every color, and the toner image of each color is superposed successively on the transferring belt 11. On the other hand, while the timing roller 82 controls timing for forwarding the recording medium 9 so as to adjust the tip portion of the image to the tip of the recording medium 9. The timing roller 82 forwards the recording medium 9 at the timing for forwarding, and then the recording medium 9 is forwarded via the leading guide 81, and is in pressed contact with the transferring belt 11.

Thereby, the image superposed on the transferring belt 11 is transferred onto a recording medium 9 in one-step. In this case, a voltage (+1500 to 2000V) opposite in polarity to the charged polarity of toner is applied to the second transferring roller 76 from the second transfer power supply 77 for electrostatic transfer.

A cleaning blade 79 scrapes toner that remains on the transferring belt 11 without being transferred on to the recording medium 9. A part of the toner, which is scraped from the transferring belts 11, is used for the next image forming process.

A method for producing the transferring belt according to Embodiment 3 of the present invention is basically the same as described in the method of Embodiment 1 and Embodiment 2. The producing method of this embodiment and the required characteristics for the transferring belt are described as follows.

A method for producing a fixing belt according to Embodiment 3 of the present invention comprises:
applying a release layer containing fluoropolymers on a die surface of a shaping die;
baking the release layer applied;
applying an elastic layer over a surface of the release layer, the surface of the release layer being opposite the die surface as viewed from the release layer;
baking the elastic layer applied;
applying a supporting layer containing heat-resistant synthetic resin over a surface of the elastic layer, the surface of the elastic layer being opposite the die surface as viewed from the elastic layer;
baking the supporting layer applied;
removing unevenness of the baked supporting layer; and
releasing the release layer, the elastic layer and the supporting layer from the die surface.

Each process in the method for producing the transferring belt will be described. In FIG. 11, the same components as those of FIG. 4 are attached with the same reference symbols or numerals.

First, each layer, which composes the transferring belt 11, is described, with reference to FIG. 11. It is preferable that the fluoropolymers used for a release layer 2 is at least one selected from the group including tetrafluoroethylene polymer (PTFE), tetrafluoroethylene-perfluoroalkoxyethylene copolymer (PFA), and fluoridation ethylene propylene copolymer (PFEP).

In addition, it is preferable that the baking temperature of the release layer 2 is 330-430 degrees in Celsius. In this temperature range, the release layer 2 can be preferably formed, and degradation of the release layer 2 can be prevented. Additionally, it is preferable that the thickness of the release layer 2 is 5-50 μm. In this thickness range, the abrasion durability of the release layer 2 is preferable, and the removing effect can be maintained for a long time, and fracture of the release layer 2 can be prevented. In particular, it is more preferable that the range is 10-25 μm.

A conductive agent, a wear resistance agent, and so on can also be added in this release layer 2, if necessary. Carbon black, an ionic conductive agent, conductive resin, or the like can be used as the conducting agent. Concretely, titanium oxide, tin oxide, barium sulfate, aluminum oxide, titanic acid strontium, magnesium oxide, a silicon oxide, carbonic acid silicon, silicon nitride, or the like can be used as conductive inorganic particles. Carbon surface treatment and so on can be performed thereto, if necessary. Ammonium salt, alkyl sulfonate salt, phosphoric acid ester, or the like can be used as the ionic conductive agents. In addition, polyvinylaniline, polyvinylpyrrole, fourth-grade ammonium salt, or the like can be used as the conductive resin.

The material is not specifically limited to ones described above. However, it is preferable to use conductive inorganic particles with respect to conductivity control. It is preferable that the surface resistance of the transferring belt 11 of this embodiment is 109-1016 Ω/cm (measured at 10 seconds after applying 500 V, by an HRS probe (inner diameter ring f6 mm, outer diameter ring 18 mm) of the Hiresta IP, Mitsubishi Petrochemical Corporation), and it is more preferable that the surface resistance of the transferring belt 11 is 1011-1012 Ω/cm.

In addition, it is preferable that the elastic layer 3 is formed of silicone rubber with JIS hardness A of 1 to 80 degrees. In this JIS hardness A range, the reduction in strength and poor adhesiveness of the elastic layer 3 can be prevented. The thickness is preferably 30-1000 μm, and more preferably 100-400 μm. In this thickness range, when the toner image is transferred from the photoconductive drum 32 onto the transferring belt 11, image defects, such as so-called “defect of hollow image,” which is insufficient transferring in a fine line, can be prevented.

Here, when there is partial long lines of toner image in the subscanning direction, the transferring belt 11 is in contact only with the toner image parts and is not in contact with the other parts. When this phenomenon occurs, a hollow image appears. In greater detail, the reason for this phenomenon is that the pressure of the first transferring roller 74 is collectively applied only to the toner image parts in the transferring belts 11.

In this embodiment, since the elastic layer 3 is formed in a transferring belt 11, the transferring belt 11 deforms flexibly. The pressure of the first transferring roller 74 is also applied to parts other than the toner image parts in the transferring belts 11, and the above collectively applied pressure can be reduced. Thereby, defect of hollow image can be reduced. Furthermore, in order to adjust resistance, a conductive agent can also be added in the elastic layer 3, if necessary. The same agents as the release layer 2 can be used for the conductive agent to be added.

It is preferable that the supporting layer 4 is heat-resistant synthetic resin. It is preferable that heat-resistant synthetic resin is polyimide (PI) or polyamide imide (PAI).

In addition, it is preferable that the baking temperature of the supporting layer is 150-300 degrees in Celsius. In this temperature range, reduction in the strength of the supporting layer 4 cannot occur, and deterioration in the elastic layer 3 can be prevented. Additionally, it is preferable that the thickness of the supporting layer 4 after baking is 50-200 μm. In this thickness range, while the strength and wear resistance of the supporting layer 4 can be kept sufficient, reduction in its flexibility cannot occur.

The transferring belt 11 is stretched for use around a plurality of axes (a driving roller 12, a tension roller 13, etc.). Therefore, when the transferring belt 11 is left without being used for a long time, the transferring belt 11 may become abnormally deformed. Accordingly, the transferring belt 11 is not in normal contact with the axes. This causes defects such as slip or colors out of register.

However, in the above range of the thickness of the supporting layer 4 after baking, such defects do not occur. In addition, the supporting layer 4 should have an additional thickness (for example, approximately 5-20 μm) for polishing after baking as described below. Furthermore, in order to adjust resistance, a conductive agent can also be added in the supporting layer 4, if necessary. The same agents as the release layer 2 can be used for the conductive agent to be added.

It is preferable that the finished volume resistance of the whole transferring belt is adjusted to 1×106 Ω·cm to 1×1010 Ω·cm after the transferring belt 11 is produced by the method mentioned above. It is more preferable that the volume resistance of the transferring belt 11 of this embodiment is 108 Ω·cm to 109 Ω·cm (measured at 10 seconds after applying 500 V, by an HRS probe (inner diameter ring f6 mm, outer diameter ring 18 mm) of the Hiresta IP, Mitsubishi Petrochemical Corporation).

In this volume resistance range, the transferring belt 11 can be repeatedly used, or can be used with stable performance under environmental change. If the resistance exceeds this resistance range, a charge is accumulated inside by the voltage applied at transferring. Accordingly, the predetermined voltage cannot be applied. Therefore, print quality deteriorates.

On the other hand, if the resistance is less than this resistance range, the current applied at primary transferring leaks through a plurality of axes, which support the transferring belt 11. Adequate transfer voltage cannot be retained; therefore, transfer efficiency reduces remarkably.

Next, the method for producing transferring belt according to Embodiment 3 will be described with reference to FIG. 11. In addition, the producing apparatus in FIG. 5 and the polishing apparatus in FIG. 6 according to Embodiment 1 can be used in each following process.

First, as shown in FIG. 11(a), a shaping die 1 with the predetermined shape of die surface 1a is prepared. Additionally, in FIG. 11, although a die surface 1a is illustrated as a flat plane, the die surface 1a is actually a surface of a cylindrical shape, which is a convex shape facing downward.

Next, as shown in FIG. 11(b), a release layer 2 containing fluoropolymers is applied on the die surface 1a by a spray downwardly facing in the vertical direction, for example.

Next, the shaping die 1 is heated for baking. Baking can be performed by maintaining a uniquely predetermined temperature in a predetermined time. In addition, baking may be performed following a profile for temperature rising time previously set by a program.

Next, as shown in FIG. 11(c), an elastic layer 3 is applied onto the external surface of the release layer 2.

Next, the shaping die 1 is heated again and the elastic layer 3 is baked according to a predetermined manner and at a predetermined temperature.

Then, as shown in FIG. 11(d), a supporting layer 4 is applied on the elastic layer 3, and the applied supporting layer 4 is heated and baked.

However, when applying the supporting layer 4, as shown in FIG. 11(d), a thinner part and a thicker part often appear. This causes the unevenness in the transferring belt 11 after baking.

The surface of the supporting layer 4 is polished with a file belt or the like by the polishing apparatus of FIG. 6 or the like in order to bring the surface to the state shown in FIG. 11(e). At polishing, the file belt is thrust onto the surface rotating at the axis as the center of the shaping die. It is preferable that the file roughness is approximately #300 to #1000. Polishing process can be performed several times with file belts having different roughness.

In this embodiment, the surface roughness of the supporting layer 4 finally obtained is 10-20 μm in ten-point average surface roughness. Thus, the surface roughness of the transferring belt 11 can be smaller than the surface roughness of the driving roller 12, and the surface roughness of the tension roller 13. Polishing the supporting layer 4 can be performed not only after baking the supporting layer 4 but also after drying the supporting layer 4 in the manner similar to Embodiment 1, etc.

Finally, the transferring belt 11 is released from the shaping die 1, and then, the transferring belt 11 is turned inside out.

In addition, in this embodiment, the coefficient of linear thermal expansion of a release layer 2 is 10×10-5 to 12×10-5 per degree in Celsius, and the coefficient of linear thermal expansion of the supporting layer 4 is approximately 5.4×10-5 per degree in Celsius.

When a transferring belt 11 is heated to approximately 200 degrees in Celsius and then is cooled to room temperature, against a width 200 mm of the transferring belt 11, the release layer 2 contracts approximately 4 mm and the supporting layer 4 contracts approximately 2 mm (almost half of the release layer 2). Thus, when they have different coefficients of linear thermal expansion, the difference in the inner diameters between the release layer 2 and the supporting layer 4 is canceled. Therefore, when a transferring belt 11 is turned inside out, wrinkles cannot appear on the surface of the transferring belt 11.

The transferring belt 11 in this embodiment comprises a release layer 2 containing fluoropolymers and positioning at the outermost layer, a supporting layer 4 containing heat-resistant synthetic resin and positioning at the innermost layer, and an elastic layer 3 positioning between the release layer 2 and the supporting layer 4, wherein unevenness of the is removed after the supporting layer 4 is dried or baked.

In this construction, the evenness of the transferring belt 11 is secured, and pressure unevenness can be reduced.

In this embodiment, the apparatus further has a plurality of rollers 12, 13, . . . , which the transferring belt 11 is stretched around, wherein the surface roughness of the supporting layer 4 after polishing is smaller than those of the plurality of rollers 12, 13, . . .

In this construction, the transferring belt 11 is high in contact with the plurality of rollers 12, 13, . . . , which the transferring belt 11 is stretched around. Moreover, the rotational speed variation caused by the unevenness of a transferring belt 11 is reduced. Therefore, the color registration can be stable, and a preferable image can be obtained.

In this embodiment, the unevenness of the supporting layer 4 is removed after the baking process or the drying process.

In this construction, by removing the unevenness of the supporting layer 4, the surface of the supporting layer 4 opposite from the die surface becomes flat. Therefore, the pressure unevenness by the transferring belt 11 is reduced, and the recording quality can be improved.

In this embodiment, the apparatus further has a cleaning unit for removing toner that remains on the transferring belt 11. The cleaning unit includes a cleaning blade 79 with elasticity.

In this construction, it is possible to prevent a problem caused by the perimeter difference produced according to the forming order of the layers in the transferring belt 11, and the expansion and contraction induced when the supporting layer 4 and a release layer 2 are turned inside out. The wrinkles, which appear in the release layer 2, can be reduced.

When the transferring belt 11 is just released from the shaping die 1a, the lowest layer is the release layer 2 and the top layer is the supporting layer 4. Moreover, the coefficient of linear thermal expansion of the release layer 2 is larger than the supporting layer 4. Wrinkles tend to be formed on the surface of the release layer 2 (the lowest layer). When the released transferring belt 11 is turned inside out, the release layer 2 located in the lowest layer becomes the top layer. That is, the inner diameter of the release layer 2 becomes smaller than the inner diameter of the supporting layer 4 after the transferring belt is turned inside out, and the surface of the release layer 2 is extended. Even if wrinkles appear on the surface of the release layer 2 as the release layer 2 is just released, wrinkles disappear after the turn-over and the surface becomes flatter.

Furthermore, in order to remove the toner, which remains on the surface of the transferring belt 11, it is effective to remove it from the surface while pressing the cleaning blade 79 with elasticity.

A plurality of external additive agents, which reduce aggregation of toner and control charging, are often used in the toner other than the toner particles as main particles. Generally, the external additive agent is remarkably smaller than the toner particles. From this point of view, when the toner and the external additive agent on the transferring belt 11 are removed by the cleaning blade 79, it is preferable that the cleaning blade 79 deeply engages into the transferring belt 11, and that the edge of the cleaning blade 79 is in close contact with the surface layer of the transferring belt 11. It is effective to bring the cleaning surface of the transferring belt 11 flat by removing the unevenness of the supporting layer 4 in terms of improvement of cleaning performance.

In this embodiment, the apparatus further comprises a supporting unit (cleaning support roller 80) supporting the cleaning blade 79. The transferring belt 11 is nipped between cleaning unit and the supporting unit.

In this construction using the transferring belt with fewer wrinkles and the blade unit, the toner and the external additive agent on the transferring belt 11 can be effectively removed. In addition, the transferring belt is nipped between the cleaning blade 70 and the supporting unit. Therefore, the cleaning blade 79 is in closer contact with the surface layer of the transferring belt 11, and the removal performance of the toner or the external additive agent can be improved. In this case, the unevenness in the surface layer (or the release layer) and the supporting layer of the transferring belt 11, should be reduced as small as possible.

(Embodiment 4)

This embodiment relates to technology for providing a plurality of heating layers in the fixing belt 5. The image forming apparatus with this fixing belt 5 is similar to Embodiment 1.

With reference to FIG. 12, each layer in Embodiment 4 which composes the fixing belt 5 is described from a recording medium 9 side to a magnetic roller 39 side.

First, a release layer 61 is located at the closest side to the recording medium 9 side (upper side in FIG. 12) in the fixing belt 5, and is in contact with the recording medium 9.

It is preferable that the fluoropolymers used for the release layer 61 is at least one selected from the group including tetrafluoroethylene polymer (PTFE), tetrafluoroethylene-perfluoroalkoxyethylene copolymer (PFA), and fluoroethylene-propylene copolymer (PFEP).

Moreover, it is preferable that a baking temperature of the release layer 61 is 330-430 degrees in Celsius. In this temperature range, the release layer 61 can be preferably formed, and degradation of the release layer 61 can be prevented. Moreover, as for the thickness after baking of the release layer 61, it is preferable that it is 5-50 gm. In this thickness range, the abrasion durability of the release layer 61 is preferable, and the surface hardness is high, and a fracture of the release layer 61 can be prevented. In particular, a range of 15-25 μm is more preferable. The thickness is 20 μm in this example.

The fixing belt including these fluoropolymers as the release layer 61 has preferable characteristics of fixability, surface hardness, surface die-releasing, surface roughness, durability, and film thickness flexibility. Especially, the fixing belt has excellent characteristics of toner-fixing, toner-releasing, and durability of the release layer 61.

Additionally, conductive material, abrasion resistance material, and material with high heat conductivity may be added as filler in fluoropolymers, if necessary.

A primer layer 62 is formed of fluoride rubber or the like in thin thickness.

It is preferable that an elastic layer 63 is silicone rubber with JIS hardness A1-A80 degrees. In this JIS hardness range, while the strength and adhesiveness of the elastic layer 63 can be sufficient, poor fixion can be prevented. Concretely, silicone rubber of one-component system, two-component system, three-component system, or a greater number-component system, silicone rubber of an RTV type or an HTV type, silicone rubber of a condensation type, or addition type, or the like, can be used as this silicone rubber.

In addition, it is preferable that the baking temperature of the elastic layer 63 is 150-300 degrees in Celsius. In this temperature range, while residue of a volatile component in the elastic layer 63, and the shortage of strength can be prevented, degradation and hardening do not occur in the elastic layer 63. Additionally, it is preferable that the thickness of the elastic layer 63 after baking is 30-1000 μm. In this thickness range, while the elastic layer 63 has an elastic effect, a thermal insulation property can be kept low. Accordingly, an energy-saving effect can be high. In particular, a range of 100-300 μm is more preferable. The thickness is 115 μm in this example.

Moreover, a primer layer 64 is formed of a coupling agent, fluoride rubber, and so on.

Then, a laminate portion 72, which is laminated by a supporting layer and a heating layer alternately, is located at the closer side to the magnetic roller 39 side than the primer layer 64. The lowest surface of the laminate portion 72 in FIG. 12 is in contact with the magnetic roller 39.

The heating layer is formed of polyimide (PI) containing foil pieces of non-magnetic conductive metal (silver in this embodiment). In terms of producing, it is preferable that the heating layer includes two to five layers. In this embodiment, the heating layer includes three layers of a first heating layer 66, a second heating layer 68, and a third heating layer 70.

Then, as shown in FIG. 12, in this embodiment, the first heating layer 66, the second heating layer 68, and the third heating layer 70 have the same thin thickness (t1=t2=t3=15 μm). The first heating layer 66, the second heating layer 68, and the third heating layer 70 are not equally distributed in the laminate portion 72, and are unevenly distributed in order to be closer to the recording-medium 9 side. Thus, the distance to the recording medium 9 can be made small to improve thermal conductivity for the recording medium 9.

For this reason, in the supporting layer, the thicknesses of a first supporting layer 65, a second supporting layer 67, a third supporting layer 69, and a fourth supporting layer 71 are 15 μm, 10 μm, 10 μm, and 40 μm, respectively.

As a matter of course, the above thickness is only an example, and the present invention is not specifically limited to the thickness described above.

Next, a heating operation of the fixing belt 5 is described with reference to FIG. 13 in a case that a plurality of heating layers are provided in the fixing belt 5. When an inductive heating portion 44 is driven, alternating magnetic field shown by arrows N7 in FIG. 13 is produced similarly in the case of a single heating layer.

This alternating magnetic field passes through the first heating layer 66, the second heating layer 68, and the third heating layer 70. Accordingly, eddy currents as shown by arrows N8 flow in the first heating layer 66, the second heating layer 68, and the third heating layer 70, respectively.

In addition, as compared to the single heating layer which unifies the first heating layer 66, the second heating layer 68, and the third heating layer 70 as one body, the cross-sectional areas of the first heating layer 66, the second heating layer 68, and the third heating layer 70 are small, respectively. Therefore their resistance is larger.

Since all the first heating layers 66, the second heating layers 68, and the third heating layers 70 generate heat simultaneously, and their resistance is larger, the generated Joule heat becomes larger. For this reason, the heating efficiency as the entire fixing belt 5 is improved remarkably.

It is preferable that these supporting layers 65, 67, 69, and 71, are formed of heat-resistant synthetic resin. It is preferable that heat-resistant synthetic resin is polyimide (PI) or polyamide imide (PAI).

In addition, it is preferable that the baking temperature of the supporting layers 65, 67, 69, and 71 is 150-300 degrees in Celsius. In this temperature range, while the strength of the supporting layers can be sufficient, the deterioration in the elastic layer 63 can be prevented. In addition, it is preferable that the total thickness of the supporting layer 65, 67, 69, and 71 after baking is 50-200 μm. In this thickness range, while the supporting layer 4 maintains strength and abrasion durability and prevents lowering in flexibility, a thermal insulation property can be kept low. Accordingly, an energy-saving effect can be high.

The laminate portion 72 is formed of the alternately laminated heating layers 66, 68, 70 and the supporting layers 65, 67, 69, 71, in the fixing belts 5 of this embodiment.

In this construction, the heating layers 66, 68, and 70 are inserted between the supporting layers 65, 67, 69, and 71, and their strengths are increased. Therefore, the heating layers 66, 68, and 70 can be protected from breakage.

In the fixing belt 5 of this embodiment, the non-magnetic conductive metal is silver.

Gold with similar property is expensive. Copper tends to be easily oxidized or sulfurized. On the contrary, as in this construction, silver is not as costly, and offers stable properties. Therefore it is preferable.

In the fixing belt 5 of this embodiment, the fluoropolymers is at least one selected from the group including tetrafluoroethylene polymer (PTFE), tetrafluoroethylene-perfluoroalkoxyethylene copolymer (PFA), and fluoridation ethylene propylene copolymer (PFEP).

In this construction, the toner-releasing characteristic is made preferable.

In the fixing belt 5 of this embodiment, the supporting layers 65, 67, 69, and 71 contain heat-resistant synthetic resin, the heat-resistant synthetic resin is at least one selected from the group including polyimide (PI) and polyamide imide (PAI).

In this construction, the supporting layers 65, 67, 69, and 71 with excellent strength, heat resistance, cost advantage, or the like can be obtained.

In the fixing belt 5 of this embodiment, the heating layers 66, 68, 70 are provided in the laminate portions 72 as the two to five heating layers.

This construction is suitable for actual production.

In the fixing belt 5 of this embodiment, a plurality of heating layers 66, 68, and 70 have the same thickness.

In this construction, the forming process of the heating layers 66, 68, and 70 can be achieved by performing the same process repeatedly. Ease in production and yields can be improved.

(Embodiment 5)

Hereinafter, the difference between the present embodiment and Embodiment 4 will be described, and description of the same construction or process is omitted.

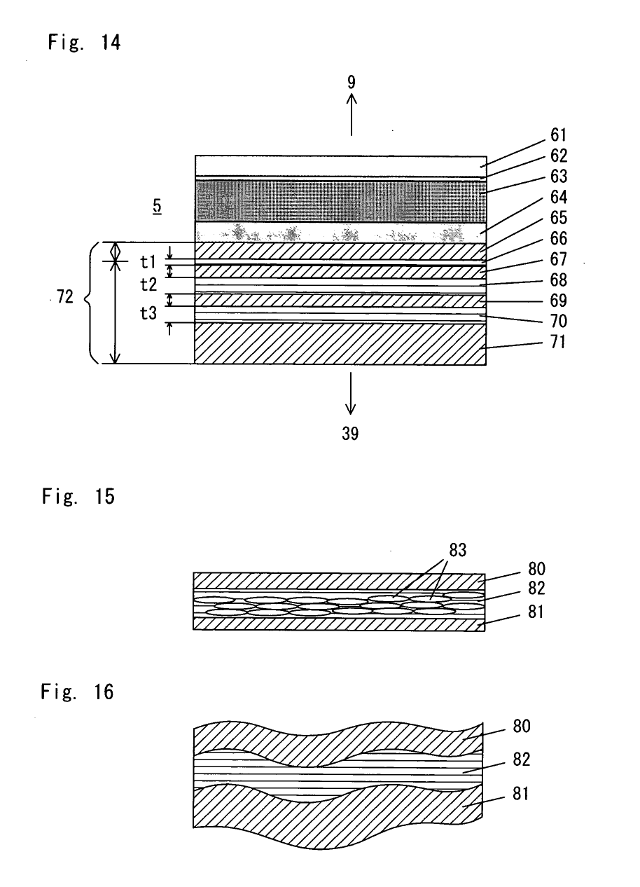

In Embodiment 5, as shown in FIG. 14, the thickness of a first heating layer 66 (e.g., t1=13 μm) is smaller than the thickness of a second heating layers 68 and a third heating layer 70 (e.g., t2=t3=16 μm).

Accordingly an electric resistance of the first heating layer 66, which is the closest to the recording medium 9, is ever larger than that of Embodiment 4, and the heating efficiency of the fixing belt 5 can be improved.

This can solve the following problems in producing a fixing belt 5. That is, polyimide (PI) or a polyamide imide (PAI) is used for a supporting layer. Each layer is applied and is baked. When the whole of the fixing belt 5 is finally baked, the supporting layer undergoes imide process, and solvent contained in the supporting layer volatilizes. Therefore, the supporting layer contracts considerably.

In addition, as an enlarged part in FIG. 15 shows, when a heating layer 82 is laminated between a supporting layer 80 and a supporting layer 81, the heating layer 82 containing silver particles 83 hardly contracts, while the supporting layer 80 and the supporting layer 81 contract considerably. The difference in the amount of contraction causes undulation as shown in FIG. 16.

According to the observation of the inventors of the present invention, this undulation especially appears remarkably near the boundary between the laminate portion 72 and the primer layer 64. Accordingly, in this embodiment, the first heating layer 66 near this boundary is thinner as if the first heating layer 66 is formed of the material similar to the supporting layer, in order to reduce the undulation.

(Embodiment 6)

An image forming apparatus of Embodiment 6 has nearly the same construction as Embodiment 1 shown in FIG. 1.

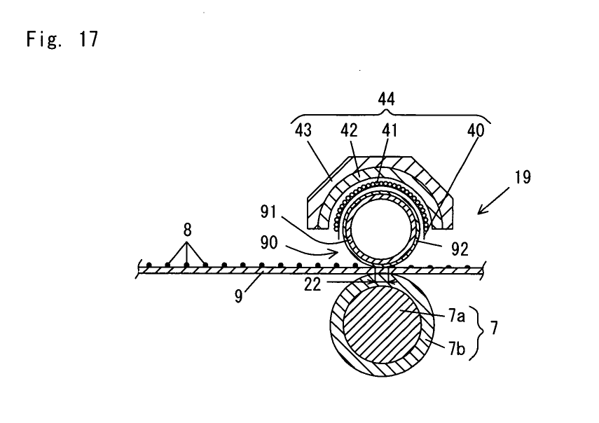

However, a heat roller fixing method is used for Embodiment 6, different from Embodiment 1. A fixing unit 19 is composed as shown in FIG. 17. A nip section 22 is formed between a magnetic roller 90 and a press roller 7.

The magnetic roller 90 includes a roller body 91 similar to the magnetic roller 39, and a combination layer 92 formed around the circumference of the roller body 91.

Moreover, the combination layer 92 is formed by the method similar to the fixing belt 5 according to Embodiment 4 or Embodiment 5. Therefore, the heating efficiency of the magnetic roller 90 can be improved rather than the case of only the roller body 91 as in the case of Embodiments 5 and 6. In addition, the combination layer 92 can be provided on the roller body 91 by either manners described below.

(1) The combination layer 92 is provided as another member from the roller body 92, just like the fixing belt. (Forming in a cylindrical shape or making an endless-shape from a belt is possible.)
(2) The layers 61 to 71, as shown in FIG. 14, are directly formed to compose the combination layer 92 on the circumferential surface of the roller body 91.

The Embodiments 4 through 6 have effects as follows.
(1) The heating layers generate heat simultaneously, and the heating efficiency can be improved. The thickness unevenness in each heating layer can be cancelled by averaging.
(2) Each heating layer is sandwiched between the supporting layers, and the heating layer can be protected from breakage.
(3) The heating layer is closer to the recording medium to be heated, and the recording medium can be heated efficiently.
(4) Moreover, the magnetic roller in the heat roller fixing method also has the same effects.

According to the present invention, the unevenness of a baked supporting layer can be removed, and the evenness of a belt can be improved, and pressure unevenness can be reduced, and recording quality can be improved.

In addition, before a supporting layer undergoes imide process, the unevenness of the supporting layer is removed, and the unevenness of elastic deformation of an elastic layer can be reduced.

Additionally, wrinkles of a release layer can be suppressed by turning a belt inside out. For example, wrinkles of the release layer can be suppressed by turning a fixing belt inside out.

Furthermore, according to the present invention, the unevenness of a baked supporting layer can be removed, and the evenness of a belt can be improved, and preferable image forming can be performed. The removal performance of toner adhering to the belt surface is improved. It is possible to obtain a belt with stable performance even used repeatedly.

Furthermore, before a supporting layer undergoes imide process reaction, the unevenness of the supporting layer is removed, and the elastic deformation of an elastic layer can be reduced. The evenness of a belt can be improved further.

Since a coefficient of linear thermal expansion of the release layer is larger than a coefficient of linear thermal expansion of the supporting layer, the surface wrinkles of a turned-inside-out transferring belt in use is reduced. A flatter surface is obtained.

Moreover, toner that remains on the surface of a belt can be more reliably removed by using a blade unit.

A belt according to the present invention can be preferably used as a fixing belt or a transferring belt in an image forming apparatus, such as, for example, a color laser printer.

In the Embodiments 4, 5 and 6, a case where the magnetic roller is used has been explained. However, the Embodiments 4, 5 and 6, can be applied to a case where a non-magnetic roller is used.

In the Embodiments 4, 5 and 6, a case where the elastic layer is provided between the release layer and the laminate portion has been explained. However, the Embodiments 4, 5 and 6, can be applied to a case where the elastic layer is not provided.

Furthermore, as described in the Embodiment 1, it is considerable to turn the fixing belt inside out, after forming in a reverse order a plurality of layers that constitute the fixing belt. Herein, when thickness of the heating layer is increased to obtain more quantity of the heating layer, the heating layer may crack when the fixing belt is turned inside out to manufacture the fixing belt.

Thinking over this problem, in the Embodiments 4, 5 and 6, the heating layer is divided into the plurality of heating layers, each of which is separated. Therefore, since each of the plurality of heating layers can be formed thin comparatively, crack of the heating layer as a whole can be avoided even when the fixing belt is turned inside out.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A method for producing a belt for an image forming apparatus, the method comprising:
applying a release layer containing fluoropolymers on a die surface of a shaping die;
baking the release layer applied;
applying an elastic layer over a surface of the release layer, the surface of the release layer being opposite the die surface as viewed from the release layer;
baking the elastic layer applied;
applying a supporting layer containing heat-resistant synthetic resin over a surface of the elastic layer, the surface of the elastic layer being opposite the die surface as viewed from the elastic layer;
baking the supporting layer applied;
removing unevenness of the supporting layer; and
releasing the release layer, the elastic layer and the supporting layer from the die surface.

2. A method as recited in claim 1, wherein the unevenness of the supporting layer is removed by polishing the supporting layer.

3. A method as recited in claim 1, the method further comprising, turning the release layer, the elastic layer and the supporting layer inside out as one body, during or after said releasing the release layer, the elastic layer and the supporting layer from the die surface.

4. A method as recited in claim 1, wherein the belt for the image forming apparatus is at least one of a fixing belt and a transferring belt.

5. A belt for an image forming apparatus, the belt comprising:
a release layer containing fluoropolymers and positioning at an outermost layer;
a supporting layer containing heat-resistant synthetic resin and positioning at an innermost layer; and
an elastic layer positioning between said release layer and said supporting layer,
wherein unevenness of said supporting layer is removed after said supporting layer is dried or baked.

6. A belt as recited in claim 5, wherein the unevenness of said supporting layer is removed by polishing.

7. A belt as recited in claim 5, wherein the belt for the image forming apparatus is at least one of a fixing belt and a transferring belt.

8. An image forming apparatus comprising:
an image forming unit operable to form a toner image;
a transferring roller operable to transfer the toner image formed by said image forming unit onto a recording medium; and
a fixing unit operable to fix the toner image onto the recording medium by melting and pressing toner constituting the toner image,
wherein said fixing unit comprises:
a heat roller;
an inductive heating portion operable to heat said heat roller by electromagnetic induction;
a fixing roller operable to be arranged separately from said heat roller;
a fixing belt operable to be stretched by said heat roller and said fixing roller; and
a press roller facing said fixing roller, said press roller and said fixing roller nipping the recording medium with the toner image transferred thereon, to form a nip section,
wherein said fixing belt comprises: a release layer containing fluoropolymers and positioning at an outermost layer; a supporting layer containing heat-resistant synthetic resin and positioning at an innermost layer; and an elastic layer positioning between said release layer and said supporting layer; and
wherein unevenness of said supporting layer is removed after said supporting layer is dried or baked.

9. A transferring belt comprising:
a release layer containing fluoropolymers and positioning at an outermost layer;
a supporting layer containing heat-resistant synthetic resin and positioning at an innermost layer; and
an elastic layer positioning between said release layer and said supporting layer,
wherein said release layer has a higher coefficient of linear thermal expansion than that of said supporting layer.

10. An image forming apparatus comprising:
an image carrier operable to retain a toner image; and
a transferring belt operable to be transferred thereon the toner image formed on said image carrier,
wherein said transferring belt comprises: a release layer containing fluoropolymers and positioning at an outermost layer; a supporting layer containing heat-resistant synthetic resin and positioning at an innermost layer; and an elastic layer positioning between said release layer and said supporting layer;
wherein unevenness of said supporting layer is removed after said supporting layer is dried or baked.

11. An image forming apparatus as recited in claim 8 further comprising: a plurality of rollers operable to stretch said fixing belt, wherein said supporting layer after the unevenness thereof is removed has smaller surface roughness than those of said plurality of rollers.

12. An image forming apparatus comprising:
an image carrier operable to retain a toner image; and
a transferring belt operable to be transferred thereon the toner image formed on said image carrier,
wherein said transferring belt comprises a release layer containing fluoropolymers and positioning at an outermost layer; a supporting layer containing heat-resistant synthetic resin and positioning at an innermost layer; and an elastic layer positioning between said release layer and said supporting layer;
wherein said release layer has a higher coefficient of linear thermal expansion than that of said supporting layer.

13. An image forming apparatus as recited in claim 12, wherein the unevenness of said supporting layer is removed after said supporting layer is dried or baked.

14. An image forming apparatus as recited in claim 13 further comprising: a cleaning unit operable to remove toner remaining on said transferring belt, wherein said cleaning unit includes an elastic blade.

15. An image forming apparatus as recited in claim 14 further comprising: a supporting unit operable to support said cleaning unit, wherein said transferring belt is nipped by said cleaning unit and said supporting unit.

16. A fixing belt comprising:
a release layer operable to work in contact with a recording medium;
a laminate portion operable to work in contact with a magnetic roller; and
an elastic layer positioned between said release layer and said laminate portion,
wherein said laminate portion includes a plurality of heating layers and a supporting layer, the plurality of heating layers containing non-magnetic conductive metal and the supporting layer being operable to support said plurality of heating layers.

17. A fixing belt as recited in claim 16, wherein said laminate portion is formed by laminating said heating layer and said supporting layer alternately.

18. A fixing belt as recited in claim 16, wherein the non-magnetic conductive metal is silver.

19. A fixing belt as recited in claim 16, wherein said laminate portion includes two to five heating layers.

20. A fixing belt as recited in claim 16, wherein said plurality of heating layers are provided at a closer position to the recording medium than to the magnetic roller in said laminate portion.

21. A fixing belt as recited in claim 16, wherein each of said plurality of heating layers has a same thickness respectively.

22. A fixing belt as recited in claim 16, wherein a layer of said plurality of heating layers is formed thinner than the other heating layer(s), the layer being located at a closest position to the recording medium.

23. A magnetic roller comprising:
a roller body including magnetic metal member; and
a combination layer provided on a circumferential surface of said roller body,
wherein said combination layer includes a release layer operable to work in contact with a recording medium; a laminate portion provided in contact with the circumferential surface of said roller body; and an elastic layer located between said release layer and said laminate portion;
wherein said laminate portion includes a plurality of heating layers and a supporting layer, the plurality of heating layers containing non-magnetic conductive metal, and the supporting layer being operable to support said heating layers.

24. A magnetic roller as recited in claim 23, wherein said laminate portion is formed by laminating said heating layer and said supporting layer alternately.

25. A magnetic roller as recited in claim 23, wherein the non-magnetic conductive metal is silver.

26. A magnetic roller as recited in claim 23, wherein said laminate portion includes two to five heating layers.

27. A magnetic roller as recited in claim 23, wherein said plurality of heating layers are provided at a closer position to the recording medium than to said magnetic roller in said laminate portion.

28. A magnetic roller as recited in claim 23, wherein each of said plurality of heating layers has a same thickness respectively.

29. A magnetic roller as recited in claim 23, wherein a layer of said plurality of heating layers is formed thinner than the other heating layer(s), the layer being located at a closest position to the recording medium.

30. An image forming apparatus comprising:
an image forming unit operable to form a toner image;
a transferring roller operable to transfer the toner image formed by said image forming unit onto a recording medium; and
a fixing unit operable to fix the toner image onto the recording medium by melting and pressing toner constituting the toner image,
wherein said fixing unit comprises:
a magnetic roller;
an inductive heating portion operable to heat said magnetic roller by electromagnetic induction;
a fixing roller operable to be arranged separately from said magnetic roller;
a fixing belt operable to be stretched by said magnetic roller and said fixing roller; and
a press roller facing said fixing roller, said press roller and said fixing roller nipping the recording medium with the toner transferred thereon, to form a nip section,
wherein said fixing belt comprises a release layer operable to work in contact with the recording medium; a laminate portion operable to work in contact with said magnetic roller; and an elastic layer located between said release layer and said laminate portion;
wherein said laminate portion includes a plurality of heating layers containing non-magnetic conductive metal, and a supporting layer operable to support said heating layers.

31. An image forming apparatus comprising:
an image forming unit operable to form a toner image;
a transferring roller operable to transfer the toner image formed by said image forming unit onto a recording medium; and
a fixing unit operable to fix the toner image onto the recording medium by melting and pressing toner constituting the toner image,
wherein said fixing unit comprises: a magnetic roller; an inductive heating portion operable to heat said magnetic roller by electromagnetic induction; a press roller facing said magnetic roller, said press roller and said fixing roller nipping the recording medium with the toner transferred thereon, to form a nip section;
wherein said magnetic roller comprises a roller body including a magnetic metal member, and a combination layer provided on a circumferential surface of said roller body;
wherein said combination layer includes a release layer operable to work in contact with the recording medium, a laminate portion provided in contact with the circumferential surface of said roller body, and an elastic layer located between said release layer and said laminate portion;
wherein said laminate portion includes a plurality of heating layers containing non-magnetic conductive metal, and a supporting layer operable to support said plurality of heating layers.
